(19) United States
(12) Patent Application Publication
(10) Pub. No.: US 2023/0165259 A1
(43) Pub. Date: Jun. 1, 2023

(54) ANTIVIRAL COMPOSITION, ANTIVIRAL PROTECTIVE FILM AND MANUFACTURING METHOD THEREOF

(71) Applicant: NAN YA PLASTICS CORPORATION, Taipei (TW)

(72) Inventors: Te-Chao Liao, TAIPEI (TW); Chun-Che Tsao, TAIPEI (TW); Chen-Ho Lai, TAIPEI (TW)

(73) Assignee: NAN YA PLASTICS CORPORATION, Taipei (TW)

(21) Appl. No.: 17/582,015

(22) Filed: Jan. 24, 2022

(30) Foreign Application Priority Data
Nov. 26, 2021 (TW) 110144105

(51) Int. Cl. A01N 59/20; A01N 25/34; A01N 25/10; A01N 25/12; A01N 59/16; A01N 25/24; A01P 1/00

(52) U.S. Cl. CPC A01N 59/20; A01N 25/34; A01N 25/10; A01N 25/12; A01N 59/16; A01N 25/24; A01P 1/00

(57) ABSTRACT

An antiviral composition comprising a resin material and metal-containing particles is provided. A particle size of the metal-containing particles ranges from 2 nm to 200 nm. Based on a total weight of the antiviral composition, the content of metal-containing particles is greater than 0.1 wt %.

### CROSS-REFERENCE TO RELATED APPLICATION

This application claims the priority benefit of Taiwan application serial no. 110144105, filed on Nov. 26, 2021. The entirety of the above-mentioned patent application is hereby incorporated by reference herein and made a part of this specification.

### BACKGROUND

### Technical Field

The invention relates to a composition, a protective film and a manufacturing method thereof, and particularly relates to an antiviral composition, an antiviral protective film and a manufacturing method thereof.

### Description of Related Art

In recent years, due to the rage of influenza viruses or COVID-19, people have become aware of the importance of how to quickly and effectively facilitate the decrease of the attachment and/or breeding of pathogens (e.g., fungi, bacteria, or viruses).

### SUMMARY

The invention is directed to an antiviral composition, an antiviral protective film, and a manufacturing method thereof, which are adapted to decrease the attachment and/or breeding of pathogens.

The invention provides an antiviral composition including a resin material and metal-containing particles. A particle size of the metal-containing particles ranges from 2 nm to 200 nm. Based on a total weight of the antiviral composition, content of the metal-containing particles is greater than 0.1 wt %.

The invention provides an antiviral protective film including a base layer, an antiviral layer, and an adhesive layer. The antiviral layer is disposed on a surface of the base layer. The antiviral layer is formed by the antiviral composition. The adhesive layer is disposed on another surface of the base layer. The base layer is disposed between the antiviral layer and the adhesive layer.

The invention provides a manufacturing method of an antiviral protective film. The method includes steps as follows. A base layer is disposed. The antiviral composition is coated on the base layer to form an antiviral layer.

Based on the above description, the antiviral composition and the antiviral protective film may decrease the attachment and/or breeding of pathogens (e.g., fungi, bacteria, or viruses).

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a schematic diagram of an antiviral protective film according to an embodiment of the invention.

FIG. 2 is a schematic diagram of usage of an antiviral protective film according to an embodiment of the invention.

### DESCRIPTION OF THE EMBODIMENTS

In the following detailed description, for the sake of explanation and not limitation, exemplary embodiments revealing specific details are set forth to provide a thorough understanding of various principles of the invention. However, it will be obvious to those skilled in the art that, benefit from the disclosure, the invention may be practiced in other embodiments that depart from the specific details disclosed herein. In addition, descriptions of well-known objects, methods, and materials may be omitted so as not to obscure the description of various principles of the present invention.

A range may be expressed herein as from “about” a specific value to “about” another specific value, and it may also be directly expressed as a specific value and/or to another specific value. When expressing the range, another embodiment includes from the one specific value and/or to another specific value. Similarly, when a value is expressed as an approximation by using the antecedent “about”, it will be understood that the specific value forms another embodiment. It will be further understood that an endpoint of each range is obviously related to or independent from another endpoint. In this specification, regarding the description method of using “about” a specific value; or omitting “about” and directly expressing the specific value, it includes the specific value and an average value of the specific value determined by those skilled in the art within an acceptable deviation, considering the discussed measurement and a specific number of measurement related errors (e.g., errors caused by other factors such as limitation of a measurement system, error propagation in a computing process, etc.). For example, the description method of using “about” a specific value; or omitting “about” and directly expressing the specific value may be expressed within ±10% of the specific value.

In the specification, non-limiting terms (such as possible, may, for example, or other similar terms) are non-essential or optional implementation, inclusion, addition or existence.

Unless otherwise defined, all terms (including technical terms and scientific terms) used herein have the same meanings commonly understood by those with ordinary knowledge in the technical field to which the present invention belongs. It will also be understood that terms (such as those defined in commonly used dictionaries) should be interpreted as having a meaning consistent with the meaning in the relevant technical background and should not be interpreted in an idealized or overly formal sense, unless explicitly defined herein.

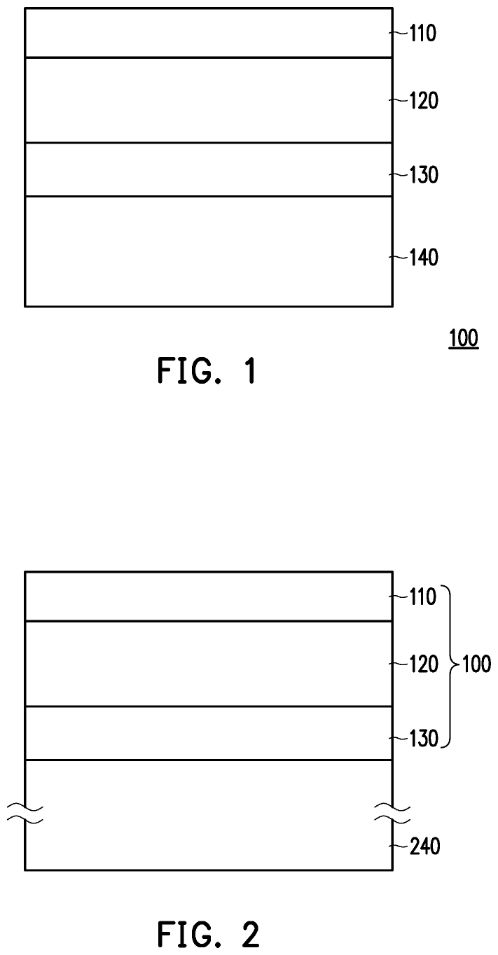

FIG. 1 is a schematic diagram of an antiviral protective film according to an embodiment of the invention. FIG. 2 is a schematic diagram of usage of an antiviral protective film according to an embodiment of the invention.

Referring to FIG. 1, an antiviral protective film 100 may include an antiviral layer 110, a base layer 120, and an adhesive layer 130. The antiviral layer 110 may be formed of an antiviral composition. Detailed content of the antiviral composition is described in the subsequent paragraphs. The base layer 120 is disposed on the antiviral layer 110. The adhesive layer 130 is disposed on the base layer 120.

In an embodiment, the base layer 120 may include a light-transmitting material. For example, the base layer 120 may include a polyester film or other suitable polymer films, but the invention is not limited thereto.

It should be noted that the terms “polyester”, “polyester material”, etc., in the specification refer to any type of polyester, especially aromatic polyester, and particularly refer to polyester derived from purified terephthalic acid (PTA) and ethylene glycol (EG) (i.e., polyethylene terephthalate (PET)). In addition, the polyester herein may also be, for example, polytrimethylene terephthalate, polybutylene terephthalate (PBT), polyethylene naphthalate, or a combination thereof.

In the embodiment, the polyester is preferably polyethylene terephthalate, polytrimethylene terephthalate, polybutylene terephthalate or a combination thereof. In addition, a copolymer may also be used, which specifically refers to a copolymer that may be obtained by using two or more dicarboxylic acids and/or two or more diol components.

Referring to FIG. 1 and FIG. 2, in an exemplary application of the antiviral protective film 100, the adhesive layer 130 of the antiviral protective film 100 may be adhered to an object 240, so that the antiviral layer 110 of the antiviral protective film 100 faces the outside to reduce attachment and/or breeding of pathogens (e.g., fungi, bacteria, and/or viruses) thereon.

Referring to FIG. 1, the antiviral protective film 100 may further include a release layer 140. The release layer 140 may be disposed on the adhesive layer.

For example, the antiviral protective film used for sales may further include a release layer. Moreover, in an exemplary application, the release layer may be torn off so that the adhesive layer may be adhered to an object. The place where the object is pasted may include a surface of an electronic product (e.g., a mobile phone or a touch screen, but the invention is not limited thereto) that is suitable for being touched, or a surface of an object that may contact a public environment (e.g., a desktop, a chair surface, a countertop or medical equipment, etc., but the invention is not limited thereto). In this way, the antiviral layer facing the outside may reduce the attachment and/or breeding of pathogens thereon. In addition, the application method and/or usage of the antiviral protective film 100 are relatively simple.

In an embodiment, the antiviral layer has a pencil hardness of 2H or more. The pencil hardness may be measured according to ASTM D3363-05 standard test method for film hardness by pencil test.

In the embodiment, the antiviral composition used to form the antiviral layer may include a resin material and metal-containing particles. A particle size of the metal particles ranges from 2 nm to 200 nm. The particle size of the metal particles within the range may have better dispersibility, overall antifungal/antibacterial/antiviral effects and/or durability. In addition, if the particle size of the metal particles is too large (e.g., more than 200 nm), it may increase a haze of the overall antiviral protective film to affect an appearance (e.g., visually similar to a white haze film surface).

In the embodiment, based on a total weight of the antiviral composition, the content of the metal-containing particles is greater than 0.1 weight percent (wt %) and less than 8.0 wt %. If the content of the metal particles is too small (e.g., less than 0.1 wt %), the antifungal, antibacterial and/or antiviral ability thereof may be probably reduced. If the content of the metal-containing particles is too high (e.g., greater than 8.0 wt %), the product appearance may probably be degraded.

In an embodiment, the metal-containing particles are selected from one of metal particles, metal salt particles, metal oxide particles, or a group consisting of the above particles.

In an embodiment, the metal in the metal-containing particles is selected from one in a group consisting of silver, titanium, aluminium, nickel, cobalt, copper, zinc, iron, and manganese.

For example, the metal-containing particles may be selected from one in a group consisting of metallic silver particles, metallic titanium particles, metallic aluminium particles, metallic nickel particles, metallic cobalt particles, metallic copper particles, metallic zinc particles, metallic iron particles, metallic manganese particles, silver salt particles, titanium salt particles, aluminium salt particles, nickel salt particles, cobalt salt particles, copper salt particles, zinc salt particles, iron salt particles, manganese salt particles, silver oxide particles, titanium oxide particles, aluminium oxide particles, nickel oxide particles, cobalt oxide particles, copper oxide particles, zinc oxide particles, iron oxide particles, and manganese oxide particles.

In an embodiment, the metal in the metal-containing particles is selected from two or more in a group consisting of silver, titanium, aluminium, nickel, cobalt, copper, zinc, iron, and manganese. In other words, the metal-containing particles have at least two or more elements selected from the group consisting of silver, titanium, aluminium, nickel, cobalt, copper, zinc, iron, and manganese. In an embodiment, corresponding ion states of at least two of the two or more metal elements may have different valences.

In an embodiment, the metal in the metal-containing particles is selected from two or more of the group consisting of silver, titanium, aluminium, nickel, cobalt, copper, zinc, iron, and manganese, and the metal-containing particles are selected from the group consisting of silver metal particles, silver salt particles, silver oxide particles. Namely, the metal-containing particles are selected from at least one in a group consisting of silver metal particles, silver salt particles, and silver oxide particles; and, the metal in the metal-containing particles is selected from one or more of the group consisting of titanium, aluminium, nickel, cobalt, copper, zinc, iron, and manganese.

In an embodiment, the metal in the metal-containing particles is selected from two or more of the group consisting of silver, titanium, aluminium, nickel, cobalt, copper, zinc, iron, and manganese, and the metal-containing particles are selected from the group consisting of silver metal particles, silver salt particles, silver oxide particles. Moreover, based on the total weight of the antiviral composition, the total content of silver metal particles, the silver salt particles and the silver oxide particles is greater than or equal to 0.01 wt %.

In an embodiment, the metal-containing particles are selected from at least one in a group consisting of silver metal particles, silver salt particles, and silver oxide particles; and the metal in the metal-containing particles is selected from two or more of the group consisting of titanium, aluminium, nickel, cobalt, copper, zinc, iron, and manganese. In an embodiment, the corresponding ion states of at least three of the three or more metal elements (i.e., silver and other two or more) may have different valences.

Compared with general organic (e.g., phenols) or non-metallic (e.g., nitroso or peroxide-containing compounds) chemical antifungal agents, chemical antibacterial agents or chemical antiviral agents, inorganic metal-containing particles are less resistant to drugs. In addition, the inorganic metal-containing particles have better slow-release properties, longer antifungal/antibacterial/antiviral effects, and/or better durability. In addition, since the inorganic metal-containing particles basically do not have volatility, they have higher safety and may be used for objects in contact with human body.

In an embodiment, in the metal-containing particles, since two or more different metal elements are selected, and due to different oxidation-reduction potentials and/or different valences of the different metal elements, the corresponding antifungal/antibacterial/antiviral effects may be correspondingly different. In this way, the antiviral composition may be widely used in antifungal/antibacterial/antiviral applications, and may have a better/wider range of antifungal/antibacterial/antiviral effects.

In an embodiment, a resin material in the antiviral composition may include a light-curing resin. The light-curing resin may be cured at least by means of illumination. In an embodiment, the light-curing resin may be cured by irradiation of ultraviolet light. In an embodiment, the light-curing resin may include poly(methyl methacrylate) (PMMA), fatty polyurethane or a copolymer thereof (e.g., polyurethane prepolymer fatty polyurethane acrylate).

In an embodiment, based on a total weight of the antiviral composition, the content of the poly(methyl methacrylate), the fatty polyurethane or the copolymer thereof may range from 20 wt % to 60 wt %.

In an embodiment, the resin material in the antiviral composition may further include epoxy resin, epoxy acrylate, polyurethane acrylate, polyester acrylate, polyether acrylate, pure acrylic resin, silicone oligomer or a combination thereof, but the invention is not limited thereto. Based on a total weight of the antiviral composition, the content of epoxy resin, epoxy acrylate, polyurethane acrylate, polyester acrylate, polyether acrylate, pure acrylic resin, silicone oligomer or the combination thereof may be between 32 wt % and 79.9 wt %.

In the embodiment, the manufacturing method of the antiviral protective film may include following steps. An antiviral composition is covered on a surface of a base layer by means of coating. Then, the antiviral composition covering the base layer is cured through a suitable curing method (e.g., light curing) to form an antiviral layer. On another surface of the base layer, a corresponding adhesive layer and/or release layer may be formed at an appropriate time (e.g., after forming the antiviral layer; or before coating the antiviral composition).

In an embodiment, a thickness of the antiviral layer may be between 0.02 mm and 0.5 mm. If the thickness of the antiviral layer is too thick (e.g., more than 0.5 mm), the cost may be increased and/or an overall light transmittance or appearance of the antiviral protective film is affected. If the thickness of the antiviral layer is too thin (e.g., less than 0.02 mm), the antiviral layer is more likely (but not necessarily) to be damaged.

In an embodiment, the antiviral layer may be a stack of multiple film layers. In addition, in the stacked multiple film layers, at least one of the layers is formed of the antiviral composition.

### EXAMPLES AND COMPARATIVE EXAMPLES

Embodiments and comparative examples are shown below to describe the invention in detail, but the invention is not limited by the following examples at all.

Each embodiment and comparative example may form a corresponding antiviral protective film according to the above-mentioned method. In each embodiment and comparative example, a material and/or a structure (such as a thickness or a relative position) of each layer are basically the same, a difference there between lies in the type of the metal-containing particles or the corresponding amount of addition in the composition that forms the antiviral layer (or a similar film layer that is the same in structure but different in material).

Compositions and corresponding evaluation items of [Example 1] to [Example 3] and [comparative example] are shown in [Table 1].

In the following embodiment and comparative example, antifungal evaluation may be performed according to ASTM G21 standard practice for determining resistance of synthetic polymeric materials to fungi that is established by American society for testing and materials (ASTM). If an evaluation object (such as the subsequent embodiment or the comparative example) has an antifungal effect of grade 0 (i.e., no fungus growth) for a test fungus, it means that the evaluation object has the antifungal effect for the test fungus.

In the following embodiment and comparative example, antibacterial evaluation may be performed according to JIS (Japanese industrial standards) Z 2801 antibacterial test standards (antibacterial processed product-antibacterial test method antibacterial effects) in the JIS. If an antibacterial activity value of the evaluation object (such as the subsequent embodiment or the comparative example) for a test culture is greater than or equal to 2.0, it means that the evaluation object has an antibacterial effect for the test culture.

In the following embodiment and comparative example, antiviral evaluation may be performed according to ISO (international organization for standardization) 21702:2019 antiviral detection standard (measurement of antiviral activity on plastics and other non-porous surfaces) established by the ISO. If an antiviral activity value of the evaluation object (such as the subsequent embodiment or comparative example) for a test virus is greater than or equal to 2.0, it means that the evaluation object has an antiviral effect for the test virus.

The antifungal, antibacterial and/or antiviral testing, evaluation or identification may be (but not limited to), for example, performed by a following third-party impartial unit: Societe Generale de Surveillance (SGS) or a testing unit certified by SGS; or, Japan BOKEN (general financial institution foundation BOKEN quality evaluation organization) or a testing unit certified by Japan BOKEN.

In the following embodiment and comparative example, visible light transmission (VLT) and/or a haze in a visible light wavelength range may be measured by a Hunterlab®-UltraScan PRO spectrophotometer. In addition, the numerical values shown in the embodiments and comparative example may be relative numerical values (e.g., corresponding to a same standard product).

TABLE 1

| | | | | | Comparative |
|---|---|---|---|---|---|
| Items | | Embodiment 1 | Embodiment 2 | Embodiment 3 | example |
| Types of metal-containing | Silver phosphate | 0.016 wt % | 0.008 wt % | 0.000 wt % | 0.000 wt % |
| particles and proportions | Zinc oxide | 0.240 wt % | 0.120 wt % | 0.240 wt % | 0.000 wt % |
| of total weight of | Titanium dioxide | 0.008 wt % | 0.004 wt % | 0.008 wt % | 0.000 wt % |
| corresponding antiviral | | | | | |
| composition | | | | | |
| Antiviral protective | Relative penetration | 90.08% | 90.53% | 90.12% | 91.08% |
| film appearance | Relative haze | 2.01% | 1.14% | 1.91% | 1.06% |
| | Scratch resistance level | 2H or more | 2H or more | 2H or more | 2H or more |
| Antibacterial effect | Escherichia coli | >6.24 | 4.16 | 1.87 | 0.08 |
| | Staphylococcus aureus | >4.24 | 2.90 | 1.08 | 0.04 |

In addition, antifungal effect evaluation is performed on [Example 1] and [Example 2], by using any one of Aspergillus niger, Penicillium tetrapine, Chaetomium globosum, Gliocladium virens and Aureobasidium pullulans for testing, the antifungal effects of the [Example 1] and the [Example 2] are all at grade 0.

Moreover, further antifungal effect evaluation is performed on [Example 1] and [Example 2], by using any one of Aspergillus niger, Penicillium tetrapine, Chaetomium globosum, Gliocladium virens and Aureobasidium pullulans for testing, the antifungal effects of the [Example 1] and the [Example 2] are all at grade 0.

In addition, further antifungal effect evaluation is performed on [Example 3], by using any one of Aspergillus niger, Penicillium tetrapine, Chaetomium globosum, Gliocladium virens and Aureobasidium pullulans for testing, the antifungal effect of [Example 3] may be probably grade 1 (the fungus still grows, but a fungus growth area is less than 10%).

Moreover, further antibacterial effect evaluation is performed on [Example 1] and [Example 2], by using any one of Pneumoniae, Escherichia coli, Staphylococcus aureus, drug-resistant Staphylococcus aureus, Salmonella and Pseudomonas aeruginosa for testing, antibacterial activity values of [Example 1] and [Example 2] are both greater than or equal to 2.0.

Taking [Example 2] as an example, the antibacterial activity value of each test culture is shown below. Pneumoniae: greater than 5.76. Escherichia coli: about 4.16. Staphylococcus aureus: about 2.90. Drug-resistant Staphylococcus aureus: about 3.60. Salmonella: about 2.59. Pseudomonas aeruginosa: greater than 5.10.

Comparing with a certain same test culture, the antibacterial effect of [Example 1] is better than that of [Example 2].

In addition, further antiviral effect evaluation is performed on [Example 1], and the H1N1 influenza virus is used for testing, and an antiviral activity value of [Example 1] is about 3.9.

Moreover, as [Example 1] to [Example 3] are compared with [Comparative example], the appearance (e.g., visible light transmittance and/or haze) and/or practicality (e.g., scratch resistance) of the anti-viral protective film within the corresponding metal-containing particle addition range may all be within an acceptable range of general industrial utilization.

In summary, the antiviral composition of the invention and/or the antiviral protective film formed by the antiviral composition may have better antifungal, antibacterial and/or antiviral effects.

### INDUSTRIAL UTILIZATION

The antiviral composition of the invention may form a corresponding antiviral protective film. The antiviral protective film of the invention may be covered (e.g., by adhering) on a surface of an electronic product adapted to be touched (e.g., a mobile phone or a touch screen, but the invention is not limited thereto) or on a surface of an object that may be in contact with the public environment (e.g., a desktop, a chair surface, a countertop or medical equipment, etc., but the invention is not limited thereto). In this way, the antiviral layer facing the outside may reduce the attachment and/or breeding of pathogens thereon.

What is claimed is:

1. An antiviral composition, comprising:
a resin material; and
metal-containing particles, wherein a particle size of the metal-containing particles ranges from 2 nm to 200 nm, and based on a total weight of the antiviral composition, content of the metal-containing particles is greater than 0.1 wt %.

2. The antiviral composition as claimed in claim 1, wherein the metal-containing particles are selected from one of metal particles, metal salt particles, metal oxide particles, or a combination group thereof, and a metal in the metal-containing particles is selected from at least one combination group of silver, titanium, aluminium, nickel, cobalt, copper, zinc, iron, and manganese.

3. The antiviral composition as claimed in claim 2, wherein the metal in the metal-containing particles is selected from two or more combination groups of silver, titanium, aluminium, nickel, cobalt, copper, zinc, iron, and manganese.

4. The antiviral composition as claimed in claim 3, wherein the metal-containing particles comprise at least one of silver particles, silver salt particles, and silver oxide particles.

5. The antiviral composition as claimed in claim 1, wherein a material of the resin material comprises poly(methyl methacrylate), fatty polyurethane or a copolymer thereof.

6. The antiviral composition as claimed in claim 5, wherein based on a total weight of the antiviral composition, content of the poly(methyl methacrylate), content of the fatty polyurethane, or content of the copolymer thereof ranges from 20 wt % to 60 wt %.

7. The antiviral composition as claimed in claim 5, wherein the material of the resin material further comprises epoxy resin, epoxy acrylate, polyurethane acrylate, polyester acrylate, polyether acrylate, pure acrylic resin, silicone oligomer or a combination thereof.

8. An antiviral protective film, comprising:
a base layer;
an antiviral layer, disposed on a surface of the base layer and formed by the antiviral composition as claimed in claim 1; and
an adhesive layer, disposed on another surface of the base layer, wherein the base layer is disposed between the antiviral layer and the adhesive layer.

9. The antiviral protective film as claimed in claim 8, further comprising:
a release layer, disposed on the adhesive layer.

10. A manufacturing method of an antiviral protective film, comprising:
disposing a base layer; and
coating the antiviral composition as claimed in claim 1 on the base layer to form an antiviral layer.
